(19) United States
(12) Patent Application Publication
(10) Pub. No.: US 2010/0066737 A1
(43) Pub. Date: Mar. 18, 2010

(54) DYNAMIC-STATE ESTIMATING APPARATUS, DYNAMIC-STATE ESTIMATING METHOD, AND PROGRAM

(76) Inventor: Yuyu LIU, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/554,041

(22) Filed: Sep. 4, 2009

(30) Foreign Application Priority Data
Sep. 16, 2008 (JP) P2008-236381

(51) Int. Cl. G06T 15/00

(52) U.S. Cl. 345/419

(57) ABSTRACT

A dynamic-state estimating apparatus includes a control-point setting unit setting a plurality of control points for a three-dimensional object model; a control-point color-information acquiring unit acquiring control-point color information indicating the color at a projection position where each control point is projected on an object image; an initial control-point color-information storing unit storing the control-point color information acquired from the object image for initial setup as initial control-point color information; a control-point position estimating unit estimating the position of each control point at a current time; a current control-point color-information acquiring unit acquiring current control-point color information resulting from projection of the control point on the object image at the current time; and a likelihood calculating unit calculating a likelihood by using the current control-point color information and the initial control-point color information.

### BACKGROUND OF THE INVENTION

1. Field of the Invention

The present invention relates to a dynamic-state estimating apparatus and a dynamic-state estimating method that estimate the dynamic state of a three-dimensional object using, for example, an observed image of the three-dimensional object. The present invention also relates to a program executed by such a dynamic-state estimating apparatus.

2. Description of the Related Art

Many dynamic-state estimating methods have been proposed in which the positions and motions of three-dimensional objects are estimated while matching between the three-dimensional objects and their observed images is performed.

In a typical method among the dynamic-state estimating methods, a variation in appearance of an object caused by a positional shift or movement of the object is described in affine transformation to estimate a parameter used in the affine transformation.

However, the three-dimensional object should be a rigid body in the affine transformation. In addition, it is necessary to make a complicated calculation to transform a three-dimensional parameter into an affine transformation parameter and it is not possible to adapt to masking.

Accordingly, other dynamic-state estimating methods are proposed in, for example, Japanese Unexamined Patent Application Publication No. 2000-194859 and J. Deutscher, A. Blake, and I. Reid, 2000, “Articulated Body Motion Capture by Annealed Particle Filtering”, In Proc. CVPR, 2:126-133 (Non-patent document 1).

Japanese Unexamined Patent Application Publication No. 2000-194859 discloses a method in which the shape of a standard three-dimensional shape model similar to an object is modified on the basis of an object image cut out from an object image.

Non-patent document 1 discloses a method in which a silhouette of a person is extracted from an image that is captured and each sample point set in a model is acquired from the image to perform matching for determining whether the acquired sample point is positioned in the silhouette.

Sample points (three-dimensional control points) set for a three-dimensional model in the above manner can be used to describe any object motion, and it is possible to vary the matching method that is applied on the basis of whether each control point is masked.

### SUMMARY OF THE INVENTION

It is desirable to provide a dynamic-state estimating method for a three-dimensional object with a higher performance, compared with methods in related art.

According to an embodiment of the present invention, a dynamic-state estimating apparatus includes a control-point setting unit setting a plurality of control points for a three-dimensional object model; a control-point color-information acquiring unit acquiring control-point color information when the entity of the three-dimensional object model is projected on an object image as an object, the control-point color information indicating the color at a projection position where each control point is projected on the object image; an initial control-point color-information storing unit storing the control-point color information acquired from the object image for initial setup by the control-point color-information acquiring unit as initial control-point color information; a control-point position estimating unit estimating the position of each control point at a current time; a current control-point color-information acquiring unit acquiring current control-point color information resulting from projection of the control point whose position is estimated by the control-point position estimating unit on the object image at the current time; and a likelihood calculating unit calculating a likelihood by using the current control-point color information and the initial control-point color information.

According to another embodiment of the present invention, a dynamic-state estimating method includes the steps of setting a plurality of control points for a three-dimensional object model; acquiring control-point color information when the entity of the three-dimensional object model is projected on an object image as an object, the control-point color information indicating the color at a projection position where each control point is projected on the object image; storing the control-point color information acquired from the object image for initial setup in the control-point color-information acquiring step as initial control-point color information; estimating the position of each control point at a current time; acquiring current control-point color information resulting from projection of the control point whose position is estimated in the control-point position estimating step on the object image at the current time; and calculating a likelihood by using the current control-point color information and the initial control-point color information.

According to another embodiment of the present invention, a program causes a dynamic-state estimating apparatus to perform the steps of setting a plurality of control points for a three-dimensional object model; acquiring control-point color information when the entity of the three-dimensional object model is projected on an object image as an object, the control-point color information indicating the color at a projection position where each control point is projected on the object image; storing the control-point color information acquired from the object image for initial setup in the control-point color-information acquiring step as initial control-point color information; estimating the position of each control point at a current time; acquiring current control-point color information resulting from projection of the control point whose position is estimated in the control-point position estimating step on the object image at the current time; and calculating a likelihood by using the current control-point color information and the initial control-point color information.

With the above configuration, the control points are set for the three-dimensional object model and the control-point color information indicating the color of each control point is acquired. The initial control-point color information indicating the color of each control point is stored as an initial setting. In a dynamic-state estimating process, the position of each control point varied with time is estimated to acquire the current control-point color information indicating the color of each control point on an image resulting from projection of the control point whose position is estimated on the image. The initial control-point color information is used as hypothetical information and the current control-point color information is used as an observed value to calculate the likelihood.

According to the present invention, the dynamic state estimation is performed on the basis of not only the position of each control point but also the color information corresponding to each control point. Consequently, it is possible to achieve a higher performance, compared with dynamic state estimation in which the color information corresponding to each control point is not used.

### BRIEF DESCRIPTION OF THE DRAWINGS

FIG. 1 is a block diagram showing an example of the configuration of a dynamic-state estimating system according to an embodiment of the present invention;

FIGS. 2A and 2B illustrate a general method of setting three-dimensional control points;

FIG. 3 is a diagram illustrating a method of setting three-dimensional control points according to an embodiment of the present invention;

FIGS. 4A and 4B include other diagrams illustrating the method of setting three-dimensional control points according to the embodiment of the present invention;

FIGS. 5A and 5B include other diagrams illustrating the method of setting three-dimensional control points according to the embodiment of the present invention;

FIGS. 6A and 6B show examples of three-dimensional control points that are set in the present embodiment of the present invention;

FIG. 7 shows an example of the structure of a control-point color template;

FIG. 8 illustrates the relationship between a three-dimensional object model in the real three-dimensional space and a three-dimensional object model projected on a captured image;

FIG. 9 schematically shows examples of layered images generated in a control point extracting process according to an embodiment of the present invention; and

FIG. 10 is a block diagram showing an example of the configuration of a computer apparatus.

### DESCRIPTION OF THE PREFERRED EMBODIMENTS

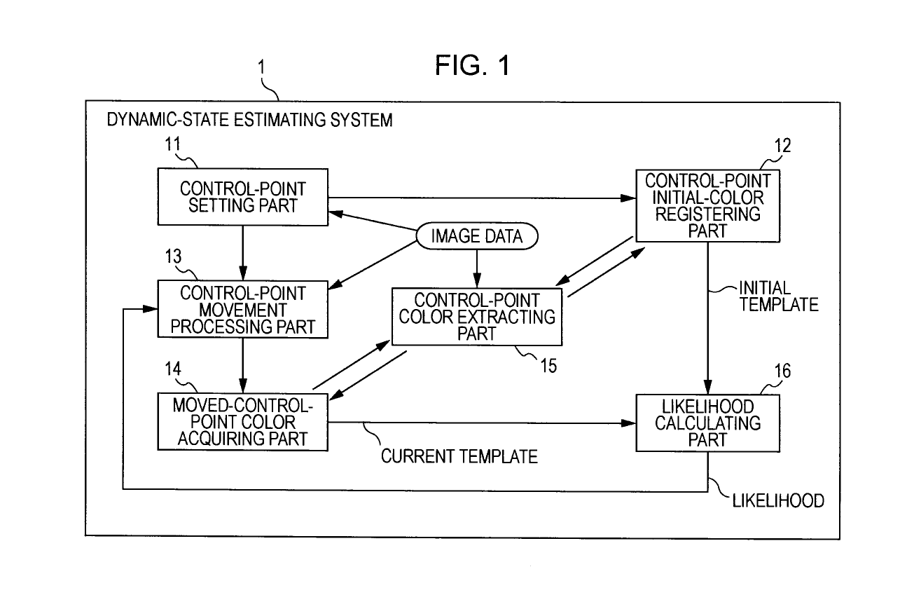

FIG. 1 is a block diagram showing an example of the configuration of a dynamic-state estimating system 1 corresponding to a dynamic-state estimating apparatus according to an embodiment of the present invention.

Referring to FIG. 1, the dynamic-state estimating system 1 of the present embodiment includes a control-point setting part 11 (control-point setting means), a control-point initial-color registering part 12 (initial control-point color-information storing means), a control-point movement processing part 13 (control-point position estimating means), a moved-control-point color acquiring part 14 (current control-point color-information acquiring means), a control-point color extracting part 15 (control-point color-information acquiring means), and a likelihood calculating part 16 (likelihood calculating means).

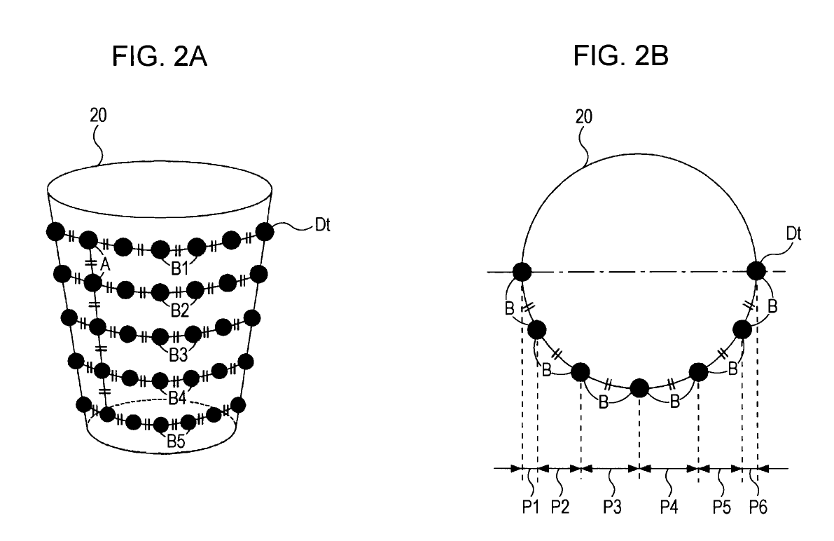

The control-point setting part 11 sets each control point (three-dimensional control point) for a three-dimensional object model which results from modeling of a three-dimensional object and whose dynamic state is to be estimated as one initial setting for a dynamic-state estimating process. How the control-point setting part 11 sets each control point will now be described with reference to FIGS. 2A to 5B.

FIG. 2A is a perspective view of a three-dimensional object model 20 whose dynamic state is to be estimated. The three-dimensional object model 20 shown in FIG. 2A has a shape of a tapered frustum of a cone.

Control points Dt of a necessary number are set on the surface of the three-dimensional object model 20 having a certain specific shape so as to have a positional relationship providing uniformity.

In order to uniformly arrange the control points Dt, for example, a method in which the control points Dt are arranged in a matrix so that a certain distance is kept between adjacent control points Dt for every row and for every column is often used in related art.

In the example shown in FIG. 2A, a distance A is set between vertically adjacent control points Dt in each column including five control points Dt.

Distances B1 to B5 are set between horizontally adjacent control points Dt in the first to five rows, respectively, each including seven control points Dt. However, since the three-dimensional object model 20 in the example in FIG. 2A has a shape of a tapered frustum of a cone in which the diameter of the three-dimensional object model 20 is decreased from the top to the bottom, the distance B1 between adjacent control points Dt in the top row has a maximum value. The distance between adjacent control points Dt is decreased toward the bottom and the distance B5 between adjacent control points Dt in the bottom row has a minimum value.

However, when the control points are set so that certain distances are kept between adjacent control points Dt on the surface of the three-dimensional object model 20 in the above manner, the uniformity is greatly degraded on an image resulting from projection of the three-dimensional object model 20.

For example, FIG. 2B is a plan view of the three-dimensional object model 20 and illustrates the seven control points Dt in one row. When the control points Dt are set so that a certain distance B (corresponding to any of the distances B1 to B5) is kept between adjacent control points Dt in the above manner, the distance between adjacent control points Dt is varied depending on the position of the row, as shown by distances P1 to P6 viewed from a side. This shows that the distance between adjacent control points Dt is varied from the distance P1 to the distance P6 on an image resulting from projective transformation of the three-dimensional object model 20.

The dynamic-state estimating system 1 of the present embodiment uses images of the three-dimensional object model 20 which are formed with time as observed images in the dynamic state estimation process described below. When the observed images are used to set the control points for the three-dimensional object model in the manner according to the present embodiment, it is preferred that the control points be uniformly arranged in an image resulting from the projective transformation of the three-dimensional object model in order to achieve a higher estimation accuracy.

Accordingly, the control points are set in the following manner in the present embodiment.

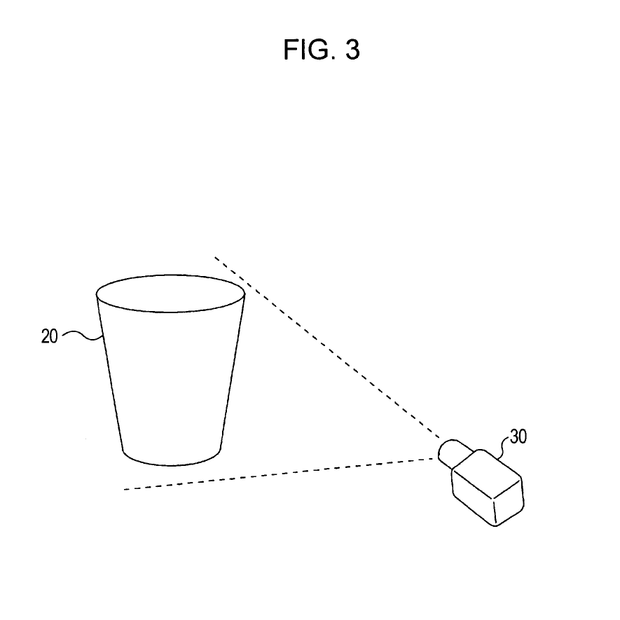

In the setting of the control points in the present embodiment, a state in FIG. 3 is assumed in which an image of the three-dimensional object model 20 is captured by an image pickup apparatus 30.

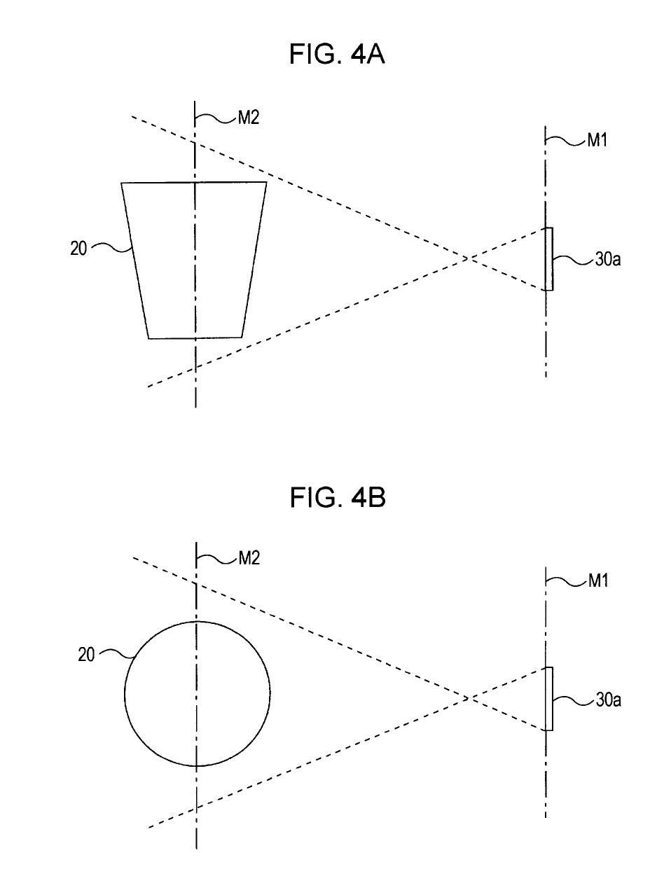

FIGS. 4A and 4B are a side view and a plan view, respectively, of the state in which an image of the three-dimensional object model 20 is captured by the image pickup apparatus 30 in the manner shown in FIG. 3.

An imaging plane 30a where the light from a captured image reaches is formed in the image pickup apparatus 30. The imaging plane 30a corresponds to a light receiving surface of an image pickup device when the image pickup apparatus is provided with the image pickup device.

It is assumed that the three-dimensional object model 20 is cut along a plane (model cutting plane) that is parallel to the imaging plane 30a. In FIGS. 4A and 4B, alternate long and short dash lines Ml indicate a plane along the imaging plane 30a and alternate long and short dash lines M2 indicate the model cutting plane in parallel with the plane (that is, the imaging plane 30a) corresponding to the alternate long and short dash lines M1.

A maximum cross section of the three-dimensional object model 20 cut long the cutting plane corresponding to the alternate long and short dash lines M2 is set as a reference cross section.

The three-dimensional object model 20 has a shape of a tapered frustum of a cone having circular horizontal cross sections, as described above. Accordingly, the three-dimensional object model 20 has the maximum cross section when the cutting plane, that is, the alternate long and short dash lines M2 is along the radius of each circular horizontal cross section of the three-dimensional object model 20, as shown in FIG. 4B.

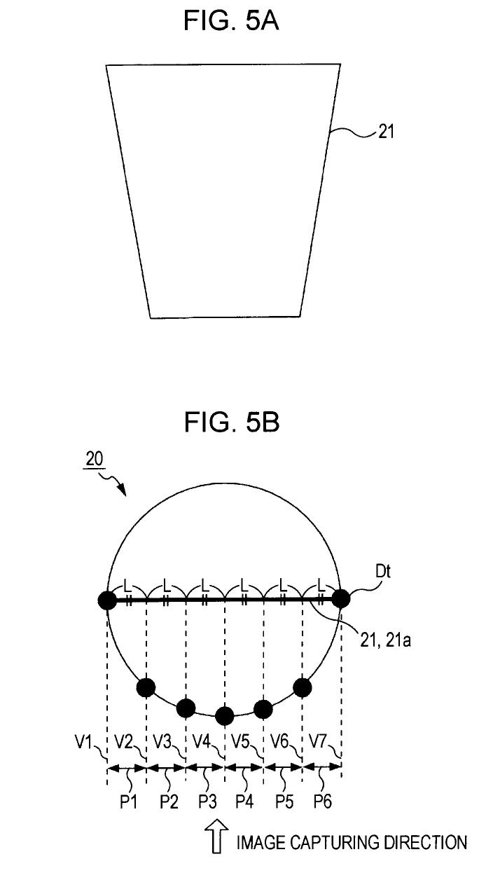

FIG. 5A shows a reference cross section 21 of the three-dimensional object model 20 given by the above method.

FIG. 5B is a plan view of the three-dimensional object model 20, illustrating the reference cross section 21.

According to the present embodiment, a line (a reference line 21a) corresponding to the reference cross section 21 is equally divided into line segments of a number corresponding to the number of control points Dt in one row, as shown in FIG. 5B. In the example in FIG. 5B, since the number of the control points Dt in one row is equal to seven, the reference line 21a is equally divided into six line segments. A length of each ling segment is denoted by L.

Then, straight lines V1 to V7 are assumed. The straight lines V1 to V7 pass through the both ends of the reference line 21a and the five points that are between the both ends and that result from the equal division. The control points Dt are set at positions where the straight lines V1 to V7 intersect with the surface of the three-dimensional object model 20. The control points are set for every row in the same manner. In addition, the control points are set for every column in a similar manner depending on the actual shape of the three-dimensional object model 20.

When the control points Dt are set in the above manner, the distance between adjacent control points in one arrangement direction, that is, in one row or in one column is varied depending on the positions of the control points. However, when the control points Dt are projected onto a two-dimensional plane in parallel with the reference cross section 21, a certain distance is kept between adjacent control points Dt in one arrangement direction. Specifically, distances P1 to P6 shown in FIG. 5B are equal to the length L resulting from the equal division of the reference line 21a.

As a result, when an image of the three-dimensional object model 20 is captured by the image pickup apparatus 30 from a direction (image capturing direction) shown by an outline arrow in FIG. 5B, the certain distance is kept between adjacent control points Dt (projective points) on the captured image.

According to the present embodiment, the control-point setting part 11 sets the control points in the manner described above. Accordingly, the control points on each observed image are more uniformly arranged, compared with, for example, the case in FIGS. 2A and 2B in which the control points are arranged at equal intervals on the surface of the three-dimensional object model 20.

The control-point setting part 11 receives an image in which the three-dimensional object model 20 whose dynamic state is to be estimated exists as an object, that is, an image (image data) of the entity of the three-dimensional object model 20 captured by the image pickup apparatus 30 in the manner shown in FIG. 3 as an initial setup image (an object image for initial setup). In the initial setup image, the entity of the three-dimensional object model 20 is fixed in a positional state in which the three-dimensional object model 20 faces the image pickup apparatus 30 so as to point to a direction appropriate for the setting of the control points. Accordingly, image data on a captured still image of the three-dimensional object model 20 may be used as the initial setup image.

The control-point setting part 11 sets the control points of a necessary number on the captured image of the three-dimensional object model 20 by the method described above with reference to FIGS. 2A to 5B.

In the setting of the control points, the distance from the image pickup apparatus 30 to the three-dimensional object model 20, which is the object, the angle of view in the image pickup apparatus 30 (zoom ratio), and other image capturing parameters are set in advance. Accordingly, these predetermined parameters can be used to determine the position where each control point is projected on the captured image.

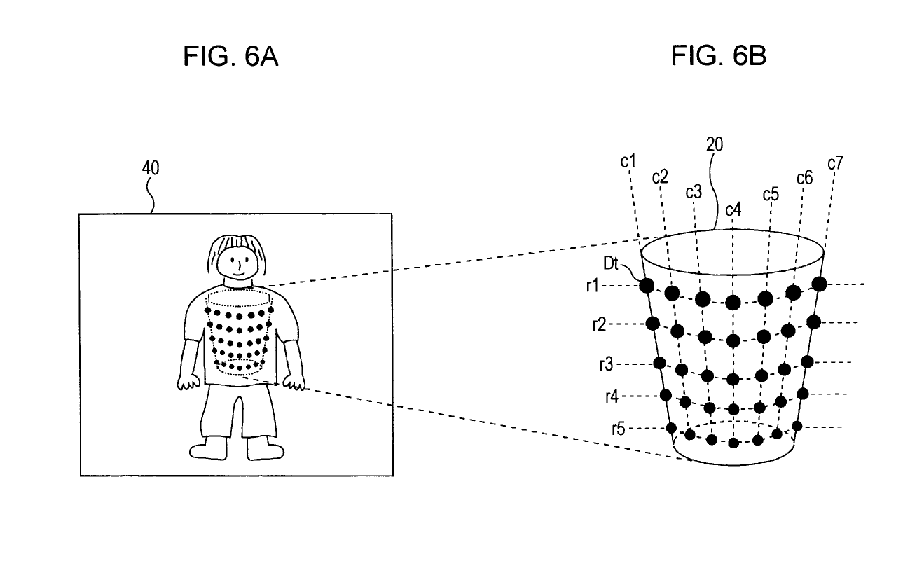

FIGS. 6A and 6B schematically show examples of the control points set by the control-point setting part 11 in the above manner.

Referring to FIG. 6A, an image of the entity of the three-dimensional object model 20, which is an object, is included in a captured image 40 captured by the image pickup apparatus 30. The entity of the three-dimensional object model 20 is a person and a front image of the person is captured by the image pickup apparatus 30.

In the example in FIG. 6A, the body of the person, which is the entity of the three-dimensional object model 20, is used as the three-dimensional object model 20. The control points are set at the positions on the captured image 40, which are determined by the method described above with reference to FIG. 3 to 5B. FIG. 6B shows an exemplary arrangement pattern of the control points set for the three-dimensional object model 20.

In the exemplary arrangement pattern shown in FIG. 6B, row r1 to r5 are vertically arranged from the top to the bottom and columns c1 to c7 are horizontally arranged from the left to the right. Thirty-five control points (5 rows×7 columns) are arranged in a matrix in the example in FIG. 6B.

After the control-point setting part 11 sets the control points on the captured image in the initial setup process described above, the control-point initial-color registering part 12 shown in FIG. 1 registers information about the initial color of each control point as initial setup information.

In order to register the initial setup information, it is necessary for the control-point initial-color registering part 12 to acquire the color information corresponding to each control point set by the control-point setting part 11. The acquisition of the color information corresponding to each control point is performed by the control-point color extracting part 15.

Specifically, the control-point color extracting part 15 extracts the color information on the position where each control point is set by the control-point setting part 11 from the initial setup image. The color information extracted in the above manner is used as information about the initial color of each control point.

The control-point initial-color registering part 12 registers initial color information corresponding to each control point set by the control-point setting part 11 as the initial setup information.

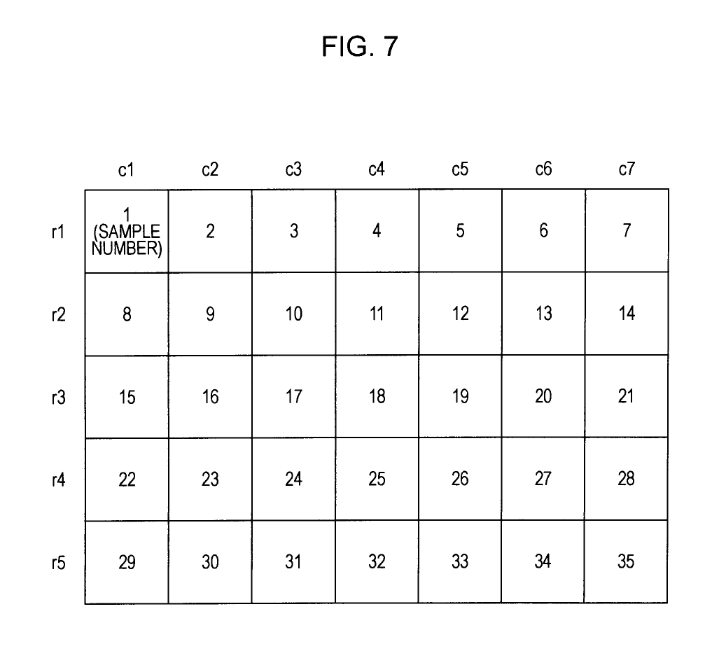

The color information corresponding to each control point is provided in a template format schematically shown in FIG. 7 in the present embodiment. The template format of the color information corresponding to each control point is also referred to as a control-point color template.

The control-point color template shown in FIG. 7 corresponds to the control points that are set in the manner shown in FIG. 6B.

Referring to FIG. 7, 35 squares composed of the rows r1 to r5 and the columns c1 to c7, which correspond to the arrangement pattern of the control points shown in FIG. 6B, are arranged in a matrix. Each square in the control-point color template corresponds to the color information about each control point arranged in the manner shown in FIG. 6B.

Sample numbers 1 to 35 assigned to the squares (color information) will be described below.

In order to create the control-point color template corresponding to the initial color information, the initial color information corresponding to each control point extracted by the control-point color extracting part 15 is set for each square in FIG. 7.

In the configuration shown in FIG. 1, data in the control-point color template corresponding to the initial color information may be generated by the control-point color extracting part 15 or may generated by the control-point initial-color registering part 12 with the color information corresponding to each control point received from the control-point color extracting part 15. In either case, the control-point initial-color registering part 12 acquires the control-point color template (initial control-point color information) corresponding to the initial color information.

The control-point color template corresponding to the initial color information is hereinafter also referred to as an “initial template”.

The control-point initial-color registering part 12 registers the data in the initial template acquired in the above manner as the initial setup information. In other words, the control-point initial-color registering part 12 stores the data in the initial template acquired in the above manner in a predetermined storage area. For example, a storage device, such as a random access memory (RAM) or a flash memory, is actually used as the storage area.

After the initial setup process, that is, the process of registering the initial template is completed, the dynamic-state estimating apparatus 1 uses image data on a captured moving image of the three-dimensional object model 20 as an observed value, as described below, to perform the dynamic-state estimating process for the three-dimensional object model 20 in a three-dimensional space.

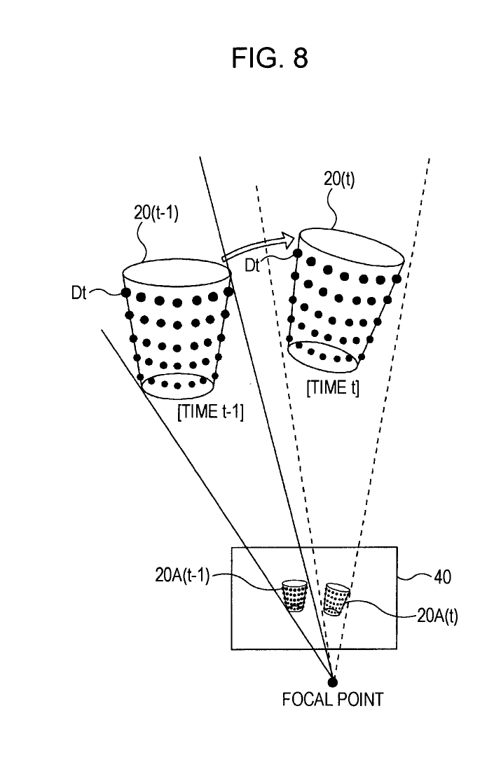

FIG. 8 schematically shows an example of how to perform the dynamic-state estimating process according to the present embodiment. The relationship between the three-dimensional object model 20 in the real three-dimensional space and a projected model image, which is a projected image of the three-dimensional object model 20 on the captured image 40, is shown in FIG. 8.

Referring to FIG. 8, an image of a three-dimensional object model 20(t-1) having certain orientation and positional states in the real three-dimensional space is captured by the image pickup apparatus 30 at a previous time t-1 to generate a projected model image 20A(t-1), which is an image of the three-dimensional object model 20 on the captured image 40.

In response to the movement of the three-dimensional object model 20, the orientation and position of the three-dimensional object model 20(t-1) at the previous time t-1 are shifted to the orientation and position of a three-dimensional object model 20(t) at the current time t. In response to the shift of the three-dimensional object model 20, the projected model image 20A(t-1) at the previous time t-1 is moved to a projected model image 20A(t) at the current time t on the captured image 40.

As described above, in the dynamic-state estimating process according to the present embodiment, the dynamic state of a three-dimensional object model is estimated on the basis of the actual movement of the object.

The dynamic-state estimating process according to the present embodiment is mainly realized by the control-point movement processing part 13, the moved-control-point color acquiring part 14, the control-point color extracting part 15, and the likelihood calculating part 16 that perform the following processes on the assumption that the control points have been set for the three-dimensional object model 20 and the initial setup for registering the initial template has been made.

The control points set for the three-dimensional object model 20 in the above manner are also moved in response to the movement of the three-dimensional object model 20 in the manner described above with reference to FIG. 8.

The control-point movement processing part 13 moves the control points Dt that are set in response to the movement of the three-dimensional object model 20. Specifically, the control-point movement processing part 13 estimates and traces the position of each control point Dt at the current time t.

When an algorithm using a particle filter is applied as an example of the tracing algorithm, the control-point movement processing part 13 performs, for example, the following process.

First, the control-point movement processing part 13 acquires likelihood information output from the likelihood calculating part 16 described below. The likelihood information is processed as information at the previous time t-1. Next, the control-point movement processing part 13 acquires image data (corresponding to the captured image 40), which is an observed image at the current time t. The control-point movement processing part 13 selects a particle on the basis of the weights of particles at the previous time t-1. The control-point movement processing part 13 predicts the position of the selected particle at the current time t by using, for example, a uniform motion model. Then, the control-point movement processing part 13 estimates the position of each control point Dt on the three-dimensional space at the current time t on the basis of the result of the prediction.

The algorithm used by the control-point movement processing part 13 to move the control points, that is, the algorithm for estimating the position of each control point is not restricted to the algorithm using the particle filter, and various algorithms for object tracing and orientation tracing (orientation estimation) may be adopted.

After the position of each control point at the current time t is set (estimated) by the control-point movement processing part 13 in the above manner, the moved-control-point color acquiring part 14 acquires color information corresponding to each control point at the current time t. This color information is also acquired as the control-point color template, as in the initial color information.

The control-point color template including the color information corresponding to each control point at the current time t is hereinafter also referred to as a “current template” to be discriminated from the “initial template”, which is the control-point color template including the initial color information.

In the acquisition of the current template, the control-point color extracting part 15 extracts the color information corresponding to each control point from the image data at the current time t, as in the initial template.

Specifically, the control-point color extracting part 15 projects the control point Dt at the current time t estimated by the control-point movement processing part 13 on the observed image (the captured image 40) at the current time t. As a result, the position of each control point estimated at the current time t is set in the observed image at the current time t. The control-point color extracting part 15 extracts the color information indicating the color represented at the position where each control point is set in the observed image at the current time t.

However, the pattern of the points (projection points) at which the control points are projected on the observed image may not actually be matched with the grid of the pixels composing the observed image. In other words, the distance between adjacent projection points in the captured image 40 may become larger or smaller than the size of one pixel.

If the distance between adjacent projection points is smaller than the size of one pixel, the image data can be acquired by interpolation. However, if the distance between adjacent projection points is larger than the size of one pixel, the direct extraction of the color information from the pixel corresponding to each projection point in the observed image is equivalent to resampling of image data at a sampling frequency lower than that of the image data in the observed image. If the sampling frequency is lower than a predetermined value in this case, an aliasing noise can be caused in data resulting from the resampling corresponding to the extraction of the color information.

In order to avoid such a situation, for example, the following method can be adopted.

Specifically, if the distance between adjacent projection points is higher than or equal to a predetermined value, the boundaries are defined between the projection points and each projection point is included in any of the image areas surrounded by the boundaries. Then, the average value of the pixels included in each image area is calculated and the calculated average value is used as the color information about the control point corresponding to each projection point. If the distance between adjacent projection points is lower than the predetermined value, the interpolation value of the pixel corresponding to each projection point is calculated and the calculated interpolation value is used as the color information.

However, since it is necessary to make a complicated calculation to define the boundary in the above method, the above method is disadvantageous for high-speed processing.

According to the present embodiment, the following method is adopted by the control-point color extracting part 15 to extract the color information.

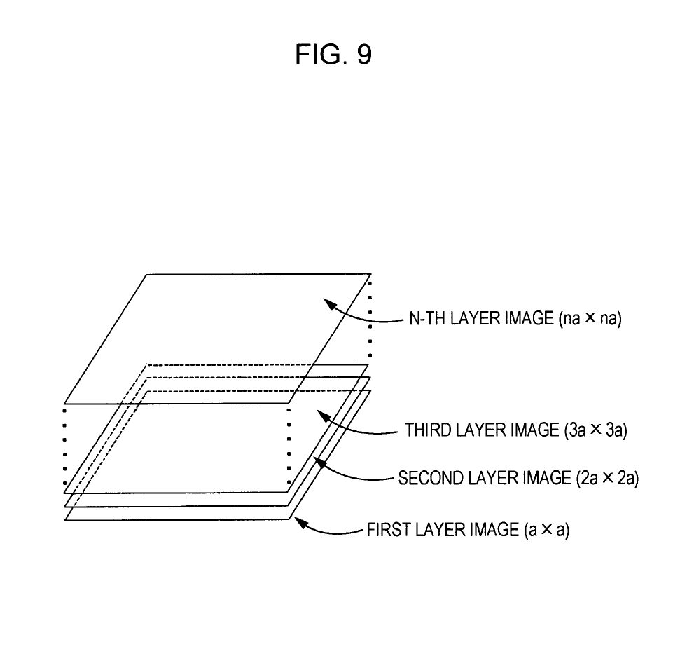

The control-point color extracting part 15 generates images from a first layer image to a n-th layer image for the color extraction on the basis of the image data (observed image data) in the observed image (the captured image 40) at the current time t, as in an example shown in FIG. 9.

The first layer image results from resampling of the observed image data at the current time t at a resolution in a minimum unit of a×a (the number of horizontal pixels×the number of vertical pixels). When a=1, the first layer image is equivalent to the observed image data at the current time t.

The second layer image results from resampling of the observed image data at the current time t at a resolution in a minimum unit of 2a×2a (the number of horizontal pixels×the number of vertical pixels). Similarly, the third layer image results from resampling of the observed image data at the current time t at a resolution in a minimum unit of 3a×3a (the number of horizontal pixels×the number of vertical pixels) and the n-th layer image results from resampling of the observed image data at the current time t at a resolution in a minimum unit of na×na (the number of horizontal pixels×the number of vertical pixels). Accordingly, the resolutions are reduced stepwise from the first layer image equivalent to the observed image data at the current time t to the n-th layer image.

In order to extract the color information corresponding to one projection point (target projection point) set on the observed image, the control-point color extracting part 15 calculates the distance between the target projection point and each adjacent projection point and selects a minimum distance (a target-projection-point minimum distance) from the calculated distances. The selected target-projection-point minimum distance is denoted by d.

The pixels corresponding to the target projection points are resampled from two layer images: a d1 layer image and a d2 layer image. The d1 layer image corresponds to an integer value (denoted by d1) given by rounding down the target-projection-point minimum distance d. The d2 layer image corresponds to an integer value (denoted by d2) given by rounding up the target-projection-point minimum distance d. Then, the value resulting from linear interpolation of the resampled pixel values is acquired as the color information (target-control-point color information) about the control point corresponding to the final target projection point. The color information is calculated according to, for example, Equation (1):

PixelVal(·)=(d−└d┘)PixelVal_{┌d┐}(·)+(┌d┐−d) PixelVal_{└d┘(·)} (1)
d . . . Target-projection-point minimum distance
└·┘. . . Round-down
┌·┐. . . Round-up
PixelVal(·) . . . Value of target-control-point color information
PixelVal_{┌d┐}(·) . . . Pixel value sampled from ^{┌d┐} layer image
PixelVal_{└d┘}(·) . . . Pixel value sampled from ^{┌d┐} layer image

The acquisition of the color information corresponding to each target control point in the above manner is equivalent to resampling of pixels from the captured image 40 resulting from sampling at a sampling frequency lower than that of the original image, thus causing no aliasing noise. Since it is not necessary to perform a complicated process, for example, the definition of the boundary for each projection point in the image data, the color information corresponding to each control point can be rapidly extracted with a simple process.

The moved-control-point color acquiring part 14 acquires data in the current template that is created on the basis of the color information corresponding to each control point (projection point) extracted in the above manner and that has the schematic structure shown in FIG. 7. Also in this case, the generation of the data in the current template may be performed by the control-point color extracting part 15 or the moved-control-point color acquiring part 14.

The method of extracting the color information corresponding to each target control point, performed by the control-point color extracting part 15, described above with reference to FIG. 9 (control-point color extracting process) is also applicable to the extraction of the initial color of each control point for the initial template registered by the control-point initial-color registering part 12.

The moved-control-point color acquiring part 14 acquires the data in the current template, that is, in the control-point color template at the current time t in the manner described above.

Next, the likelihood calculating part 16 performs matching between the data (hypothetical information) in the initial template acquired by the control-point initial-color registering part 12 and the data (observed value) in the current template acquired by the moved-control-point color acquiring part 14 to calculate the likelihood of each control point.

According to the present embodiment, the likelihood calculating part 16 adopts an algorithm in which the likelihood is calculated by using both the normalized correlation value between the initial template and the current template and information about the distance of a color histogram.

The normalized correlation value is calculated according to Equation (2):

$$Nc ( {T}_{0} , {T}_{t} ) = \frac{( \frac{1}{N} {\sum }_{i = 1}^{N} {T}_{0} ( i ) {T}_{t} ( i ) - ( \frac{1}{N} {\sum }_{i = 1}^{N} {T}_{0} ( i ) ) ( \frac{1}{N} {\sum }_{i = 1}^{N} {T}_{t} ( i ) ) )}{\sqrt{\begin{matrix}( \frac{1}{N} {\sum }_{i = 1}^{N} {T}_{0}^{2} ( i ) - {( \frac{1}{N} {\sum }_{i = 1}^{N} {T}_{0} ( i ) )}^{2} ) \\ ( \frac{1}{N} {\sum }_{i = 1}^{N} {T}_{t}^{2} ( i ) - {( \frac{1}{N} {\sum }_{i = 1}^{N} {T}_{t} ( i ) )}^{2} )\end{matrix}}} \qquad ( 2 )$$

NC(T₀,Tₜ) . . . Normalized correlation value
T₀. . . Initial template
Tₜ Current template
T₀(i) . . . Initial template: intensity of sample number i
Tₜ(i) . . . Current template: intensity of sample number i

In Equation (2), a variable i indicates the sample number assigned to the color information corresponding to each control point in the initial template and the current template. The sample number is assigned to each control point, for example, in the order shown in FIG. 7.

The distance of the color histogram is calculated in the following manner.

First, the color information corresponding to each control point is converted into an HSI space in the initial template and the current template, and each of hue (H), saturation (S), and intensity (I) components is quantized. The hue (H) and saturation (S) components are quantized in eight stages of three bits and the intensity (I) component is quantized in four stages of two bits.

Then, the quantized hue (H), saturation (S), and intensity (I) values (quantized values) are used to calculate the index of the color histogram for every control point according to Equation (3). For example, in the examples shown in FIGS. 6A and 6B and FIG. 7, 35 indices of the color histogram are calculated in each of the initial template and the current templates.

index=H·32+S·4+I (3)
H . . . Quantized value of hue
S . . . Quantized value of saturation
I . . . Quantized value of intensity

Coefficients of “32”, “4”, and “1” are set for the hue (H), saturation (S), and intensity (I), respectively, in Equation (3). These settings are based on the fact that, in discrimination of colors in the color histogram, the hue (H) has the highest level of importance and the intensity (I) has the lowest level of importance. The coefficients set in Equation (3) are exemplary values and may be appropriately changed in consideration of, for example, the actual precision of the likelihood.

The total of 260 dimensions (260 bin) are prepared for the color histogram.

This is because the hue (H), the saturation (S), and the intensity (I) basically have three quantized bits, three quantized bits, and two quantized bits, respectively, and the number of quantized bits sums up to eight. Accordingly, the indices calculated according to Equation (3) can take 256 values from 0 to 255 in the decimal number system and, thus, it is necessary to set 256 dimensions for the color histogram.

However, in gray scale, the values of the hue (H) and the saturation (S) are unstable. Accordingly, when the color information is in the gray scale, only the quantized value of Equation (1) (intensity) is adopted for the control point without applying Equation (3). When only the quantize value of Equation (1) (intensity) is adopted, four dimensions (four bin) are added to 256 dimensions. Consequently, 260 dimensions are prepared for the color histogram.

The determination of whether the color information corresponding to each control point is in the gray scale is based on whether the difference between red (R), green (G), and blue (B) values indicated as the color information is within a predetermined range. If the difference is within the predetermined range, the red (R), green (G), and blue (B) values are determined to be equal to each other.

Each index of the color histogram calculated according to Equation (3) is input into the dimension (bin) of the corresponding value in the color histogram defined in the above manner in each of the current template and the initial template. This creates the color histograms corresponding to the current template and the initial template.

Since the values of the color information registered in the initial setup are fixed in the initial template, the color histogram that is created in advance may be stored as the initial setup information. In this case, the likelihood calculating part 16 acquires data in the color histogram for the initial template stored as the initial setup information when it is necessary to use the color histogram for the initial template.

After the color histogram for the current template and the color histogram for the initial template are created, the likelihood calculating part 16 calculates the distance (similarity) between the two color histograms. The distance between the color histograms can be calculated according to Equation (4) as a Bhattacharyya coefficient:

$$Bc ( {T}_{0} , {T}_{t} ) = {\sum }_{i = 1}^{M} \sqrt{{P}_{{T}_{0}} ( i ) {P}_{{T}_{t}} ( i )} \qquad ( 4 )$$

BC(T₀,Tₜ) . . . Distance between color histograms
M . . . The number of dimensions of color histogram
i . . . The number assigned to each dimension of color histogram
P_{T}_{₀}(i) . . . Color histogram for initial template: the number of inputs of dimension i
P_{T}_{ₜ}(i) . . . Color histogram for current template: the number of inputs of dimension i

The likelihood calculating part 16 uses the normalized correlation value and the distance (the Bhattacharyya coefficient) between the color histograms, calculated according to Equations (2) and (3), to calculate the final likelihood according to Equation (5):

Pr(T₀,Tₜ)=exp[−λ·(Nc(T₀,Tₜ))²−γ(Bc(T₀,Tₜ))²] (5)
λ, γ, . . . Adjustment factors
Pr(T₀,Tₜ) . . . Likelihood

The adjustment factors λ and γ in Equation (5) are adjusted in consideration of, for example, the precision of the likelihood that is actually calculated.

The inventor of the present invention confirmed that the likelihood calculation algorithm based on the normalized correlation and the likelihood calculation algorithm based on the color histogram were effective although other likelihood calculation algorithms using the initial template and the current template are applicable to the likelihood calculating part 16. Accordingly, according to the present embodiment, the above two algorithms are integrated with each other to calculate the final likelihood.

Setting of pixel map sampling points corresponding to the control points in the present embodiment for a model is described in, for example, Non-patent document 1 mentioned above. However, in the Non-patent document 1, the likelihood is calculated on the basis of how the pixel map sampling points are set in a silhouette of the model in an image.

In contrast, according to the present embodiment, the color is set for each control point and the color information corresponding to each control point in the hypothetical information and the observed value can be used in the calculation of the final likelihood. Consequently, it is possible to accurately calculate the likelihood, compared with the case in which the position of each control point is compared with the silhouette thereof without using the color information, thus achieving a higher estimation accuracy.

The dynamic-state estimating process according to the present embodiment described above, that is, the dynamic-state estimating system 1 may be realized by hardware corresponding to the functional configuration shown in FIG. 1. The dynamic-state estimating system 1 may be realized by software describing programs causing a computer to execute the process corresponding to the functional configuration shown in FIG. 1. Alternatively, such hardware may be combined with such software.

In order to realize at least part of the dynamic-state estimating process of the present embodiment by software, the programs composing the software may be executed by a computer apparatus (central processing unit (CPU)), which is a hardware resource functioning as the dynamic-state estimating system. Alternatively, a computer apparatus, such as a general-purpose personal computer, may be caused to execute the programs to give the function of executing the dynamic-state estimating process to the computer apparatus.

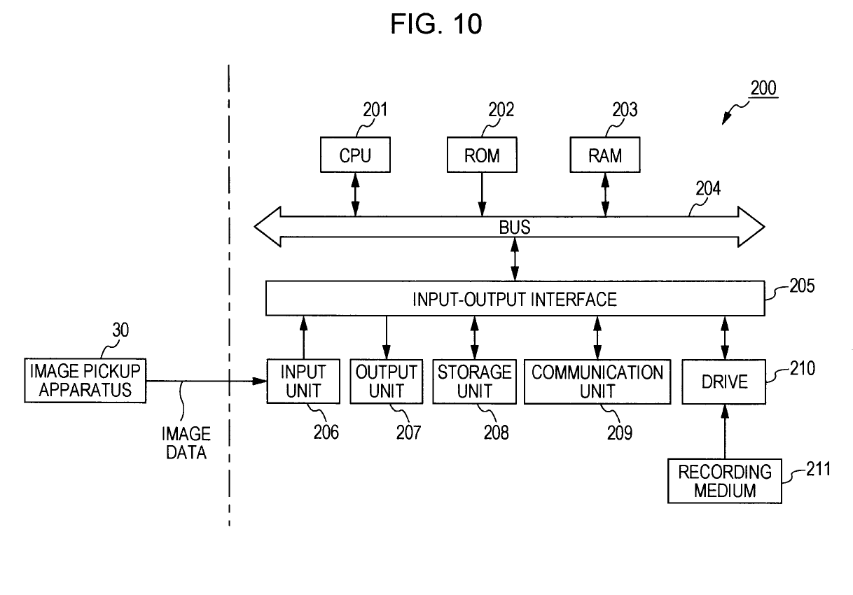

FIG. 10 is a block diagram showing an example of the configuration of a computer apparatus (information processing apparatus) capable of executing programs corresponding to the dynamic-state estimating system of the present embodiment.

Referring to FIG. 10, a computer apparatus 200 includes a CPU 201, a read only memory (ROM) 202, and a random access memory (RAM) 203 that are connected to each other via a bus 204.

An input-output interface 205 is also connected to the bus 204.

An input unit 206, an output unit 207, a storage unit 208, a communication unit 209, and a drive 210 are connected to the input-output interface 205.

The input unit 206 includes operation and input devices, such as a keyboard and a mouse. The input unit 206 is capable of receiving an image signal output from, for example, the image pickup apparatus 30 in the dynamic-state estimating system of the present embodiment.

The output unit 207 includes a display device and a speaker.

The storage unit 208 is, for example, a hard disk or a non-volatile memory.

The communication unit 209 is, for example, a network interface.

The drive 210 drives a recording medium 211, such as a magnetic disk, an optical disk, a magneto-optical disk, or a semiconductor memory.

In the computer apparatus 200 having the above configuration, the CPU 201 loads the programs stored in, for example, the storage unit 208 into the RAM 203 via the input-output interface 205 and the bus 204 and executes the loaded programs to perform the series of processes described above.

The programs executed by the CPU 201 may be recorded in the recording medium 211, which is a package medium including, for example, a magnetic disk (including a flexible disk), an optical disk (such as a compact disc-read only memory (CD-ROM) or a digital versatile disk (DVD)), a magneto-optical disk, or a semiconductor memory or may be supplied through a wired or wireless transmission medium, such as a local area network, the Internet, or digital satellite broadcasting.

The programs may be installed in the storage unit 208 through the input-output interface 205 by loading the recording medium 211 into the drive 210. The programs may be received by the communication unit 209 through the wired or wireless transmission medium to be installed in the storage unit 208. Alternatively, the programs may be installed in the ROM 202 or the storage unit 208 in advance.

In the programs executed by the computer apparatus 200, the series of processes may be performed in time series in the order described in this specification, may be performed in parallel, or may be performed in response to invocation.

The present application contains subject matter related to that disclosed in Japanese Priority Patent Application JP 2008-236381 filed in the Japan Patent Office on Sep. 16, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A dynamic-state estimating apparatus comprising:
control-point setting means for setting a plurality of control points for a three-dimensional object model;
control-point color-information acquiring means for acquiring control-point color information when the entity of the three-dimensional object model is projected on an object image as an object, the control-point color information indicating the color at a projection position where each control point is projected on the object image;
initial control-point color-information storing means for storing the control-point color information acquired from the object image for initial setup by the control-point color-information acquiring means as initial control-point color information;
control-point position estimating means for estimating the position of each control point at a current time;
current control-point color-information acquiring means for acquiring current control-point color information resulting from projection of the control point whose position is estimated by the control-point position estimating means on the object image at the current time; and
likelihood calculating means for calculating a likelihood by using the current control-point color information and the initial control-point color information.

2. The dynamic-state estimating apparatus according to claim 1,
wherein the control-point setting means arranges the control points on the surface of the three-dimensional object model so that a certain distance is kept between the projection positions in one arrangement direction.

3. The dynamic-state estimating apparatus according to claim 1 or 2,
wherein the control-point color-information acquiring means acquires the control-point color information by using the pixel value at each projection position on a resampled image resulting from resampling on the object image in a minimum sampling unit including pixels of a number that is set in accordance with the distance between adjacent control points.

4. A dynamic-state estimating method comprising the steps of:
setting a plurality of control points for a three-dimensional object model;
acquiring control-point color information when the entity of the three-dimensional object model is projected on an object image as an object, the control-point color information indicating the color at a projection position where each control point is projected on the object image;
storing the control-point color information acquired from the object image for initial setup in the control-point color-information acquiring step as initial control-point color information;
estimating the position of each control point at a current time;
acquiring current control-point color information resulting from projection of the control point whose position is estimated in the control-point position estimating step on the object image at the current time; and
calculating a likelihood by using the current control-point color information and the initial control-point color information.

5. A program causing a dynamic-state estimating apparatus to perform the steps of:
setting a plurality of control points for a three-dimensional object model;
acquiring control-point color information when the entity of the three-dimensional object model is projected on an object image as an object, the control-point color information indicating the color at a projection position where each control point is projected on the object image;
storing the control-point color information acquired from the object image for initial setup in the control-point color-information acquiring step as initial control-point color information;
estimating the position of each control point at a current time;
acquiring current control-point color information resulting from projection of the control point whose position is estimated in the control-point position estimating step on the object image at the current time; and
calculating a likelihood by using the current control-point color information and the initial control-point color information.

6. A dynamic-state estimating apparatus comprising:
a control-point setting unit setting a plurality of control points for a three-dimensional object model;
a control-point color-information acquiring unit acquiring control-point color information when the entity of the three-dimensional object model is projected on an object image as an object, the control-point color information indicating the color at a projection position where each control point is projected on the object image;
an initial control-point color-information storing unit storing the control-point color information acquired from the object image for initial setup by the control-point color-information acquiring unit as initial control-point color information;
a control-point position estimating unit estimating the position of each control point at a current time;
a current control-point color-information acquiring unit acquiring current control-point color information resulting from projection of the control point whose position is estimated by the control-point position estimating unit on the object image at the current time; and
a likelihood calculating unit calculating a likelihood by using the current control-point color information and the initial control-point color information.
